(19) United States
(12) Patent Application Publication
(10) Pub. No.: US 2026/0073944 A1
(43) Pub. Date: Mar. 12, 2026

(54) SYSTEM AND METHOD FOR CREATING SHORT SPATIAL CONTENT FROM A SPATIAL CONTENT

(71) Applicant: ZEALITY INC., Pleasanton, CA (US)

(72) Inventor: Dipak Mahendra Patel, Pleasanton, CA (US)

(21) Appl. No.: 18/882,794

(22) Filed: Sep. 12, 2024

(51) Int. Cl. G11B 27/031; G06F 3/01; G06T 19/00

(52) U.S. Cl. CPC G11B 27/031; G06F 3/013; G06F 3/017; G06T 19/006

(57) ABSTRACT

The present disclosure relates to a mechanism for creating a short spatial content from a spatial content. The mechanism includes receiving the spatial content renderable on an extended reality device for a user. Further, the mechanism includes facilitating the user to provide inputs associated with the short spatial content creation. The inputs include an initiation trigger, spatial coordinates of points of interest, a start time, and an end time. Furthermore, the mechanism includes extracting a segment of the spatial content based on the received inputs to create the short spatial content. Moreover, the mechanism includes annotating the created short spatial content to embed one or more affordances for a vivid display of the created short spatial content. The affordances include labels to facilitate a viewer to change Point-Of-View (POV) to the one or more points of interest based on the corresponding spatial coordinate.

### FIELD OF THE PRESENT DISCLOSURE

Embodiments of the present invention generally relate to extended reality systems. In particular, embodiments of the present invention relate to a system and method for creating interactive and engaging short spatial content (zizzle) from spatial content.

### BACKGROUND OF THE DISCLOSURE

In the age of digital media, immersive environments such as virtual reality (VR) and augmented reality (AR) are becoming increasingly popular. These technologies often utilize spatial content, such as 360-degree video, 360-degree images, 3D content, and other forms/formats of immersive content to provide content, offering users an immersive experience by allowing them to explore a virtual space in all directions by providing a comprehensive immersive environment. The viewer can explore all the main points of interest (POIs) within the vast amount of content in the spatial content by moving to navigate and locate key scenes/object(s) freely which allows the viewer to fully understand the context of each scene/object.

However, for users who don't have the time or interest to watch full-length spatial content, the extensive content can be overwhelming and they struggle to quickly identify and focus on the important POIs within the lengthy spatial content. In addition to the difficulty of identifying and focusing on the main points of interest, the sheer volume of visual information in lengthy spatial content can lead to sensory overload for such users. Further, there are many scenarios where short segments of these lengthy videos are needed. For example, short spatial content are often required for promotional activities, to highlight important scenes or segments, or to share key moments with a wider audience. However, the current technology pertaining to extended reality content generation and/or rendering does not provide solution to create such short videos from full length spatial content with minimal efforts.

Additionally, such spatial content of short time intervals present challenges because the time available to watch the short spatial content is very limited and the users are required to quickly identify and focus on the main points of interest (POIs). However, due to the inherent nature of spatial content where POIs can be located anywhere within the spherical view, such quick identification and focusing is very difficult. As a result, the user fails to align/orient to the scene/segment/object of concern in time and misses it affecting the overall viewing experience.

Therefore, there is a need for a system and method for the creation of short videos (for example zizzle) from a spatial content and assisting the users to direct the Field of View (FOV) to the concerned Point of View (POV) to overcome the above-mentioned drawbacks of the existing technology.

The information disclosed in this background of the disclosure section is only for enhancement of understanding of the general background of the disclosure and should not be taken as an acknowledgment or any form of suggestion that this information forms existing information already known to a person skilled in the art.

### BRIEF SUMMARY OF THE DISCLOSURE

One or more embodiments are directed to a system, a method, and a computer program product (hereinafter may also be termed “mechanism”) for creating a short spatial content from a spatial content. The spatial content may include a 360-degree video, a 360-degree image, 3D contents, and other forms/formats of immersive content. Further, the spatial content may include digital media and information that is experienced within a three-dimensional space. For the purpose of this disclosure, the short spatial content (for example zizzle) may correspond to a short compilation of one or more clips extracted from the spatial content to showcase important, impressive, and/or interesting moments of the spatial content. The mechanism includes receiving the spatial content, which is renderable on an extended reality device for a user. The spatial content provides an immersive experience, capturing a full spherical view of the environment, which the user can navigate through the extended reality interface. The mechanism facilitates the user in providing inputs associated with the short spatial content creation. The mechanism includes extracting a segment of the spatial content based on the provided inputs. The extraction ensures that the most relevant and impressive moments, as identified by the user, are included in the short spatial content. The extracted segment may then be further processed to create the short spatial content. The created short spatial content is annotated with one or more affordances. The one or more affordances are interactive elements embedded within the video. In an instance, the one or more affordances include direction labels that help viewers change their point of view to different points of interest within the video based on the corresponding spatial coordinates.

An embodiment of the present disclosure discloses a system for creating the short spatial content from the spatial content. The system includes a receiver to receive the spatial content renderable on an extended reality device for a user. The short spatial content may correspond to a short compilation of one or more clips extracted from the spatial content to showcase important, impressive, and/or interesting moments of the spatial content. By focusing on key segments and noteworthy events, the short spatial content provides viewers with a focused and dynamic overview of the content, enhancing the viewing experience by showcasing the highlights and pivotal moments that make the spatial content compelling and memorable.

In an embodiment, the system includes a user-interface to facilitate the user to provide one or more inputs associated with the creation of the short spatial content. The one or more inputs include an initiation trigger, spatial coordinates of one or more points of interest, a start time, and/or an end time. The initiating trigger includes hand gestures, figure gestures, touch, audio, text, and/or eye movement. The eye movement includes gazing at the one or more points of interest for a pre-defined time interval. The one or more spatial coordinates include 3-dimensional coordinates associated with an angle and/or an elevation of one or more frames of the points of interest.

In an embodiment, the system includes an extractor to extract a segment of the spatial content based on the received one or more inputs to create the short spatial content. The extraction of the segment is initiated upon receiving the initiation trigger. The extracted segment may be a brief collection of clips extracted from the spatial content, highlighting key, notable, and engaging moments. Further, the extracted segment may focus on impressive and engaging scenes, thereby providing a clear and impactful overview of the spatial content.

In an embodiment, the system includes a renderer to annotate the created short spatial content to embed one or more affordances for a vivid display of the created short spatial content. The one or more affordances may be annotated, based at least on one or more points of interest. In one instance, the one or more affordances include direction labels to facilitate a viewer to change Point-Of-View (POV) to the one or more points of interest based on the corresponding spatial coordinate. Furthermore, the one or more affordances are dynamic, such that the one or more affordances may re-position based on the POV of the viewer. In another instance, the one or more affordances include audio, video, text, emoji, zoom, auditory cues, interactive 3D model, hyperlinks, map, and/or social interaction tools.

An embodiment of the present disclosure discloses a method for short spatial content creation from a spatial content in an extended reality. The spatial content may include a 360-degree video, a 360-degree image, 3D contents, and other forms/formats of immersive content. Further, the spatial content may include digital media and information that is experienced within a three-dimensional space. The short spatial content may correspond to a short compilation of one or more clips extracted from the spatial content to showcase important, impressive, and interesting moments of the spatial content. The method includes receiving the spatial content renderable on an extended reality device for a user. Further, the method includes facilitating the user to provide one or more inputs associated with the creation of the short spatial content. The one or more inputs include an initiation trigger, spatial coordinates of one or more points of interest, a start time, and/or an end time. Furthermore, the method includes extracting a segment of the spatial content based on the received one or more inputs to create the short spatial content. The extracting may be initiated based on receiving the initiation trigger. In an embodiment, the method includes annotating the created short spatial content to embed one or more affordances for a vivid display of the created short spatial content. The one or more affordances may be annotated, based at least on one or more points of interest. Further, the one or more affordances include direction labels to facilitate a viewer to change Point-Of-View (POV) to the one or more points of interest based on the corresponding spatial coordinate.

An embodiment of the present disclosure discloses the computer program product comprising at least one non-transitory computer-readable storage medium having computer-executable program code portions stored therein. The computer program product is configured to receive the spatial content renderable on an extended reality device for a user. Further, computer program product is configured to facilitate the user to provide one or more inputs associated with the creation of the short spatial content. The short spatial content may correspond to a short compilation of one or more clips extracted from the spatial content to showcase important, impressive, and interesting moments of the spatial content. The one or more inputs include an initiation trigger, spatial coordinates of one or more points of interest, a start time, and/or an end time. Furthermore, computer program product is configured to extract a segment of the spatial content based on the received one or more inputs to create the short spatial content. The extraction may be initiated based on receiving the initiation trigger. In an embodiment, the computer program product is configured to annotate the created short spatial content to embed one or more affordances for a vivid display of the created short spatial content. The one or more affordances may be annotated, based at least on one or more points of interest. Further, the one or more affordances include direction labels to facilitate a viewer to change Point-Of-View (POV) to the one or more points of interest based on the corresponding spatial coordinate.

The Features and advantages of the subject matter hereof will become more apparent in light of the following detailed description of selected embodiments, as illustrated in the accompanying FIGUREs. As one of ordinary skill in the art will realize, the subject matter disclosed is capable of modifications in various respects, all without departing from the scope of the subject matter. Accordingly, the drawings and the description are to be regarded as illustrative.

### BRIEF DESCRIPTION OF THE DRAWINGS

The present subject matter will now be described in detail with reference to the drawings, which are provided as illustrative examples of the subject matter to enable those skilled in the art to practice the subject matter. It will be noted that throughout the appended drawings, features are identified by like reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 illustrates an exemplary environment having a system for creating short spatial content from a spatial content, in accordance with an embodiment of the present disclosure;

FIG. 2 illustrates a detailed block diagram of the system for creating short spatial content from the spatial content, in accordance with an embodiment of the present disclosure;

FIG. 3 illustrates an exemplary embodiment of an extended reality device, in accordance with an embodiment of the present disclosure;

FIG. 4A illustrates an exemplary interface having options for creating short spatial content from the spatial content, in accordance with an embodiment of the present disclosure;

FIGS. 4B-4D illustrate exemplary interfaces showing the short spatial content with one or more exemplary affordances, in accordance with an embodiment of the present disclosure;

FIGS. 5A-5C illustrate exemplary interfaces during interaction with the short spatial content, in accordance with an embodiment of the present disclosure;

FIG. 6 is an exemplary method for creating short spatial content from the spatial content, in accordance with an embodiment of the present disclosure; and

FIG. 7 illustrates an exemplary computer unit in which or with which embodiments of the present invention may be utilized.

### DETAILED DESCRIPTION OF THE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, semiconductor memories, such as ROMs, PROMs, random access memories (RAMs), programmable read-only memories (PROMs), erasable PROMs (EPROMs), electrically erasable PROMs (EEPROMs), flash memory or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Embodiments of the present disclosure relate to a system, method, and computer program product (hereinafter may also be termed “mechanism”) for creating a short spatial content (for example zizzle) from a spatial content. The short spatial content may correspond to a short compilation of one or more clips extracted from the spatial content to showcase important, impressive, and/or interesting moments of the spatial content. The spatial content may include a 360-degree video, a 360-degree image, 3D contents, and other forms/formats of immersive content. The 360-degree video may offer a dynamic and continuous experience, allowing for exploration in all directions as the video plays, providing a sense of presence in a moving scene. The 360-degree image may offer a static, spherical view that allows exploration in all directions, providing an immersive experience of the captured landscape. The 3D contents may include digital environments or objects that provide depth, height, and width, creating a realistic and interactive experience within a virtual or augmented space. Further, the spatial content may include digital media and information that is experienced within a three-dimensional space. In an embodiment, the spatial content may include content created using volume rendering techniques such as Gaussian splatting. The proposed mechanism includes receiving the spatial content, viewable on an extended reality device, which offers a full spherical view of an environment. Users can interact with the content through various inputs to create short spatial content. Inputs include initiation triggers like hand gestures, finger gestures, touch inputs, audio commands, text inputs, and eye movement. Users specify spatial coordinates and segment times for inclusion in the short spatial content. The mechanism includes extracting relevant video segments based on these inputs and processing them to create the short spatial content. The short spatial content is then enhanced with interactive affordances, such as direction labels, to help viewers navigate and focus on specific points of interest within the video. This approach allows users to highlight and share significant moments from their spatial content, improving accessibility and viewer engagement.

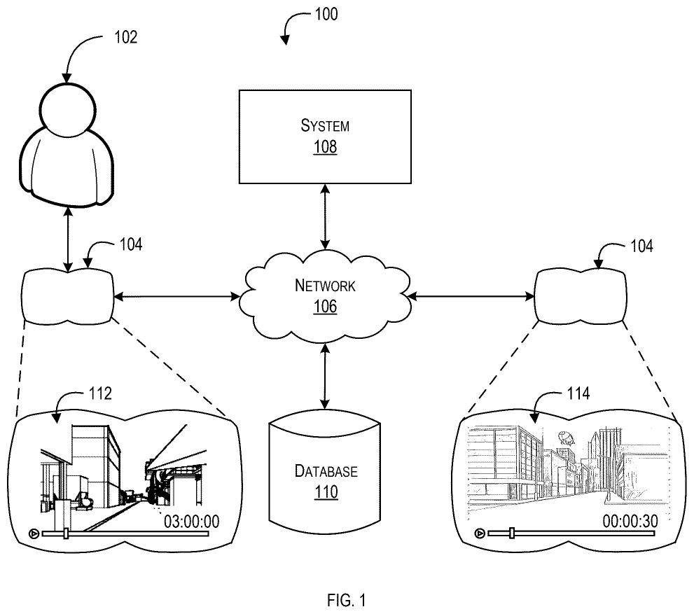

FIG. 1 illustrates an exemplary environment 100 having a system 108 for creating short spatial content 114 from a spatial content 112, in accordance with an embodiment of the present disclosure. The spatial content 112 may include a multimedia recording that captures an all-encompassing panoramic view of an environment, achieved through the use of specialized imaging technology. The specialized imaging technology may include an array of cameras or sensors arranged to capture a spherical field of view, resulting in an immersive representation of the surroundings. Unlike conventional video that presents a singular, fixed viewpoint, the spatial content 112 enables dynamic interaction by allowing users to manipulate the viewing angle in all directions—360 degrees horizontally and 180 degrees vertically—from a stationary position. Further, the short spatial content 114 may correspond to a short compilation of significant moments from the spatial content. Further, the short spatial content 114 may showcase important, impressive, and/or interesting moments of the spatial content 112. Furthermore, the short spatial content 114 may highlight key segments and points of interest (POIs) within the spatial content 112, offering a personalized and engaging experience.

In an embodiment, the creation and distribution of the short spatial content 114 may utilize any spatial content format (e.g., zcast media format, VR180, Spatial Media Metadata File (SMMF), etc) hosted within spatial worlds. The spatial content format may include spatial content, game engines, interactive objects, live/on-demand streaming, and web3 components, all supported by immersive platforms (for example ZCast by Zeality™). The immersive platform may support the integration of interactive features, such as annotative elements and multimedia overlays, enhancing engagement with the immersive content.

In an embodiment, the exemplary environment may include a user 102, display screen 104, network 106, the system 108, a database 110, the spatial content 112, and the created short spatial content 114. In an embodiment, part of the exemplary environment 100 may be implemented within the extended reality device. For example, the display screen 104 may be coupled with the extended reality device associated with the user 102, whereas the system 108 and the database 110 may be external to the extended reality device and be connected with the extended reality device via the network 106. The system 108 and the database 110 may wirelessly communicate with the display screen 104 for creating and rendering the short spatial content from the spatial content 112. The display screen 104 may extend beyond field of view of the user 102 to block surrounding ambient to the user 102. Such display screen 104 may offer an immersive virtual environment, blocking the vision of real-world environment, to the user 102. In an embodiment, the display screen 104 may be part of the extended reality device, through which the spatial content 112 may be presented to the user 102 wearing the extended reality device.

In an embodiment, the extended reality device may include, but is not limited to, head-mounted displays (HMDs), Virtual-Reality (VR) headsets, Augmented Reality (AR) glasses, handheld devices, such as mobile phones or tablets with AR capabilities. Additionally, haptic feedback devices, whether wearable or handheld, may provide tactile feedback to simulate touch and interaction within immersive environments. Spatial audio systems may be included to deliver three-dimensional sound, creating a more immersive auditory experience. Furthermore, motion-tracking sensors and controllers may be part of the extended reality device, allowing for precise tracking of user movements and interactions within the extended reality space.

In an embodiment, the spatial content 112 may be experienced by a single user or plurality of users at an instant in time. The spatial content 112 with single user may be such scenarios where the user 102 may be viewing and taking a virtual tour of a location or maybe replaying a pre-stored immersive streaming and so on. The spatial content 112 with multiple users may include virtual influencer events where fans engage with their favorite personalities in an immersive 360-degree space, or interactive brand experiences such as virtual pop-up shops and product launches that allow consumers to explore and interact with new offerings. Further, the spatial content 112 with multiple users may include gaming streams and tournaments created in a shared virtual arena where gamers and viewers may interact, comment, and participate in a collective gaming experience.

In an embodiment, a single user may be responsible for creating the short spatial content 114 from the spatial content 112, utilizing the system 108 to customize and enhance the content according to preferences. The single user might also be the viewer, directly engaging with the finalized short spatial content 114 to review and interact with the content. For example, the single user may create the short spatial content 114 with interactive elements and then immediately engage with it as the viewer, providing feedback or making adjustments based on the experience.

In an embodiment, a plurality of users may be involved in the creation or customization of the short spatial content 114. One amongst the plurality of users may act as the creator while others may serve as viewers or contributors. In an embodiment, the viewer may be an individual who may not directly be involved in the creation or customization of the short spatial content 114 but interacts with the content as an external observer. The viewer may access and experience the short spatial content 114, potentially providing feedback based on the interaction with the content.

In an embodiment, the database 110 may serve as a centralized repository for storing and organizing various types of data essential for the operation of the system 108. The database 110 may include, but is not limited to, the spatial content data, user input data, and other relevant information required for the creation and customization of short spatial content. Further, the database 110 may maintain a record of the spatial content 112, which includes immersive and interactive elements, as well as user inputs. In an embodiment, the system 108 may be configured to log data for every usage of the extended reality device, storing the information in the database 110 as historic user behavior data. The user behavior data may include data for a single user or multiple users, each with their own associated historic user behavior data. The database 110 may be cloud-based, supporting multiple extended reality devices, with dynamic, real-time data collection. The historic user behavior data may be retrieved by the system 108 to control access to both virtual and real-world environments.

The network 106 may include, without limitation, a direct interconnection, a Local Area Network (LAN), a Wide Area Network (WAN), a wireless network (e.g., using Wireless Application Protocol), the Internet, and the like. In an embodiment, the system 108 and the database 110 may be implemented in a dedicated server or a cloud-based server, for communicating with the display screen 104, thereby creating short spatial content 114 from spatial content 112 in extended reality.

In an embodiment, the system 108 may receive the spatial content 112 and, based on user 102 input, identify key moments and points of interest within the spatial content 112. The system 108 may then compile the identified key moments and points of interest to create the short spatial content 114. In an embodiment, the created short spatial content 114 may be a summarized and annotated segment of the spatial content 112. In an embodiment, the short spatial content 114 may include interactive embedding features that allow other users to engage with the content. The embeddings may include clickable elements, interactive annotations, and dynamic controls. The user 102 may interact with the embeddings to explore highlighted points of interest, view additional information, or navigate through the content. In an embodiment, the system 108 may also facilitate the sharing of the created short spatial content 114. Once created, the short spatial content 114 may be distributed to other users or integrated into various platforms through the network 106.

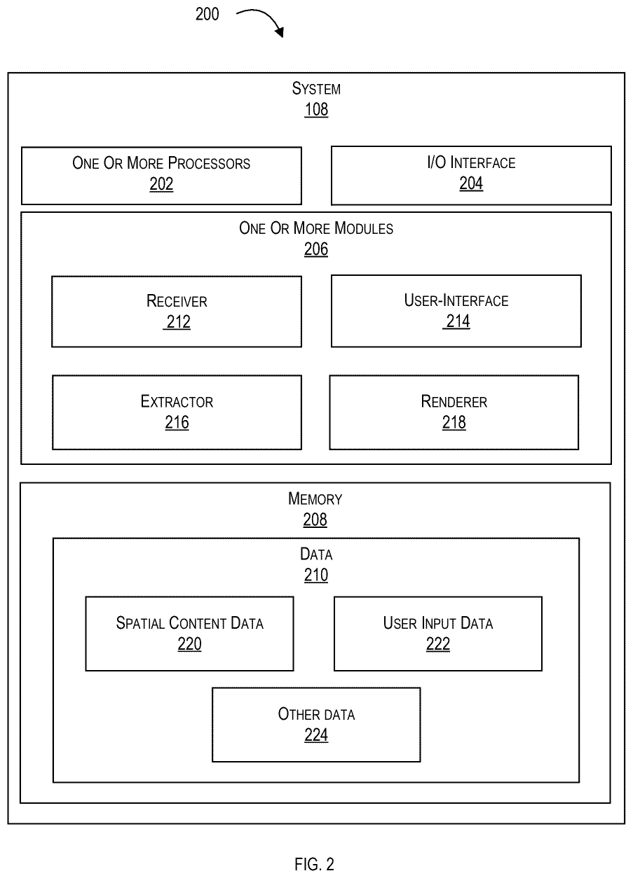

FIG. 2 illustrates a detailed block diagram 200 of the system 108 for creating short spatial content 114 from the spatial content 112, in accordance with an embodiment of the present disclosure. In an embodiment, the system 108 may include one or more processors 202, an Input/Output (I/O) interface 204, one or more modules 206, and a memory 208. The memory 208 may be communicatively coupled to the one or more processors 202. In an embodiment, the system 108 may be implemented in various computing systems, such as a laptop computer, a desktop computer, a Personal Computer (PC), a notebook, a smartphone, a tablet, e-book readers, a server, a network server, a cloud server, and the like. In an embodiment, each of the one or more modules 206 may be implemented with a cloud-based server, communicatively coupled with the system 108. The each of the one or more modules 206 may be a hardware unit, which may be outside the memory 208 and coupled with the system 108. The one or more modules 206 may be configured to perform the steps of the present disclosure using the data 120 to create and render the short spatial content 114.

In an embodiment, the memory 208 may store instructions, executable by the one or more processors 110, which, on execution, may cause the system 108 to create the short spatial content 114 from the spatial content. In an embodiment, the memory 208 may include data 210. The data 210 in the memory 208 and the one or more modules 206 of the system 108 are described herein in detail. Further, the data 210 in the memory 208 may include spatial content data 220, and user input data 222 (herewith also referred to as one or more inputs 222).

In an embodiment, the data 210 in the memory 208 may be processed by the one or more modules 206 of the system 108. The one or more modules 206 may be implemented as dedicated units and when implemented in such a manner, the modules may be configured with the functionality defined in the present disclosure to result in a novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 206 of the present disclosure function to the creation and rendering of the short spatial content 114 from the spatial content data 220. The one or more modules 206, along with the data 210, may be implemented in any system for creating and rendering the short spatial content 114 to the user 102.

In an embodiment, the one or more modules 206 may include, but are not limited to, a receiver 212, a user-interface 214, an extractor 216, a renderer 218. The receiver 212 may receive the spatial content data 220 renderable on an extended reality device for the user 102. The spatial content data 220 may include immersive content, augmented content, streaming content, and so on. In an embodiment, the receiver 212 may receive the spatial content data 220 dynamically when the spatial content data 220 is rendered to the user 102.

In an embodiment, the user-interface 214 may facilitate the user 102 to provide one or more inputs 222 associated with the creation of the short spatial content 114. The one or more inputs 222 may include an initiation trigger, spatial coordinates of one or more points of interest, a start time, and an end time. Further, the one or more inputs 222 may be provided in the virtual environment or in a real-world environment. Furthermore, the one or more inputs 222 from the user 102 may be collected by the corresponding user device and communicated with the user-interface 214. In an embodiment, the initiation trigger may include hand gestures, finger gestures, touch, audio, text, and/or eye movement. The eye movement may include gazing at the one or more points of interest for a pre-defined time interval.

In an embodiment, the hand gestures may include specific movements of the hands recognized by sensors or cameras integrated into the user device or extended reality device. The hand movements may include waving to start or stop recording, pinching fingers to select a point of interest, or swiping to navigate content. Further, the hand movement may encompass a range of actions performed by the hands that are recognized and interpreted by integrated sensors or cameras within the user device or extended reality system. Furthermore, the hand movement may facilitate interaction with digital content in virtual or augmented reality environments. For instance, waving the hand can signal the start or stop of a function, switch modes, or attract attention within the virtual space. Pointing may include extending fingers to direct focus on specific objects or areas, for a threshold period of time, often used for selecting items or indicating points of interest. Grabbing action of forming a fist or using an open hand may simulate picking up or holding an object, allowing the user 102 to interact with and manipulate virtual elements, such as dragging or moving items. Flicking may include a quick, sharp hand or finger motion used for swiftly navigating content or executing commands. Additionally, gestures like pinching and spreading, where fingers come together or move apart, are employed for zooming in or out, adjusting the scale of the view.

In an embodiment, the finger gestures may include specific movements made by the fingers, which are recognized and interpreted by the sensors or cameras integrated into the user device. Common finger gestures may include tapping, pinching, swiping, dragging, and rotating. Tapping may involve lightly touching the screen or surface with one or more fingers to select items, activate functions, or initiate commands. Pinching may involve bringing the thumb and another finger together or apart on the touch surface, commonly used for zooming in or out, thereby adjusting the view of the content. Swiping includes moving one or more fingers across the touch surface to navigate through different segments, scroll, or change views. Dragging involves holding the finger on the virtual surface and moving it to reposition items or interact with objects. Rotating consists of moving fingers in a circular motion to rotate objects or adjust angles. Multi-Touch gestures, may include placing multiple fingers on the surface simultaneously, allow for more complex interactions, such as manipulating multiple objects or performing multi-step operations. In an embodiment, the finger gestures may be detected through touchscreens, optical sensors, or gesture recognition hardware, translating into commands that the system 108 interprets to create and render interactive experiences.

In an embodiment, the touch inputs may include tapping, swiping, or dragging on a touchscreen interface to interact with the spatial content data 220. The audio inputs may include voice commands where the user 102 may speak specific instructions, such as “start recording” or “focus here,” which are recognized and processed by the system 108. The text inputs may include typed instructions or annotations provided through a keyboard or virtual keyboard interface. The eye movement inputs may include the user 102 gazing at specific points of interest for a predefined time interval, which is detected by eye-tracking sensors and interpreted as a command or input by the system 108. The system 108 may then process the gaze inputs to trigger actions such as selecting, highlighting, or providing additional information about the observed elements. The eye movement inputs may allow for a hands-free and intuitive method of interacting with the short spatial content 114, facilitating seamless engagement with the content. For example, if the user 102 looks at a particular location in the video, the system 108 may automatically zoom in on that area, display relevant annotations, or activate interactive elements related to the point of interest.

In an embodiment, the one or more spatial coordinates may correspond to 3-dimensional coordinates associated with an angle and/or an elevation of one or more frames of the points of interest. The one or more spatial coordinates may include a corresponding timestamp and a corresponding spatial stamp. The timestamp may indicate the time at which the input was provided. The spatial stamp may indicate the spatial orientation of the input on the display of the spatial content data 220.

In an embodiment, the associated user device may implement one or more timestamping and spatial stamping techniques to timestamp and spatial stamp the one or more inputs 222. In an embodiment, the user-interface 214 may collect the one or more inputs 222 along with the corresponding timestamp and corresponding spatial stamp from the user devices. In an alternate embodiment, the user-interface 214 may be implemented in the user device and communicatively coupled with the system 108. The user-interface 214 may use one or more timestamping and spatial stamping techniques to timestamp and spatial stamp the one or more inputs 222. In an embodiment, the user-interface 214 may be coupled with a user device in which the one or more inputs are provided. In an alternate embodiment, the user-interface 214 may be implemented as a centralized module in communication with the user 102. The centralized module may be configured to collect the one or more inputs 222.

In an embodiment, the one or more inputs 222 may be collected using servers that generate the spatial content data 220. In an embodiment, the one or more inputs 222 may include virtual inputs and real-world inputs. The virtual inputs may be collected by tracking the display screen 104 rendering the spatial content data 220. Further, the virtual inputs may include virtual reactions, text inputs, digital notes, and so on. The real-world inputs may be voice inputs, physical notes, user actions, facial reactions, and so on. Further, the real-world inputs may be collected using one or more sensors associated with the user devices. The one or more sensors may include a camera, a microphone, and so on. The physical notes, user actions, and so on may be collected using the camera. The voice inputs may be collected using a microphone.

In an embodiment, the extractor 216 may extract a segment of the spatial content data 220 based on the received one or more inputs 222 to create the short spatial content 114. Upon receiving the initiation trigger, the extractor 216 may process the spatial content data 220. In an embodiment, the extractor 216 may utilize an algorithm to analyze the spatial content data 220 and accurately determine the segment boundaries based on the one or more inputs 222. In an embodiment, the one or more inputs 222 may include the start time and the end time. The extractor 216 may identify the segment within the start time and the end time of the spatial content data 220 and extract the identified segment. In an embodiment, the one or more inputs 222 may include spatial coordinates identifying points of interest (POIs). The extractor 216 may utilize the spatial coordinates to incorporate the identified points of interest within the extracted segment.

In an embodiment, the renderer 218 may annotate the created short spatial content 114 to embed one or more affordances for a vivid display of the created short spatial content 114. The one or more affordances may be annotated, based at least on one or more points of interest. Further, the one or more affordances may, for example, include direction labels to facilitate a viewer to change Field-Of-View (FOV) to the one or more points of interest based on the corresponding spatial coordinate. In an embodiment, the renderer 218 may add visual indicators, such as arrows or labels, to guide the viewer attention to specific points of interest within the short spatial content 114. Further, the renderer 218 may embed interactive controls that allow the viewer to navigate through the short spatial content 114 by changing the FOV. In an embodiment, the one or more affordances may be dynamic, such that the one or more affordances may re-position based on the FOV of the viewer. The dynamic re-positioning may ensure that affordances are always within the viewer's line of sight, providing continuous guidance and interaction opportunities regardless of how the viewer moves or changes perspective within the immersive environment.

In an embodiment, the one or more affordances may also include audio, video, text, emoji, zoom, auditory cues, interactive 3D model, hyperlinks, map, and/or social interaction tools. Audio elements may include voiceovers, sound effects, or background music that provide additional context or enhance the atmosphere of the short spatial content 114. Video elements may include embedded video clips or overlays that offer supplementary visual information or highlight specific actions or events. Text elements may involve annotations, captions, or descriptions that provide explanatory information or commentary. Emoji elements may include visual symbols or icons that convey emotions or reactions, adding a layer of expressive interaction. Zoom controls allow the viewer to zoom in or out on specific areas of interest, providing a closer look at details or a broader view of the scene. Auditory cues may include sounds that draw attention to particular elements or changes within the environment, enhancing situational awareness. Interactive 3D models may involve three-dimensional representations that the viewer can interact with, rotate, or examine from different angles. Hyperlinks may include clickable links that direct the viewer to additional information or related content, expanding the depth of the viewing experience. Maps and social interaction tools may provide further context and engagement opportunities, fostering a more immersive and interactive experience.

In an embodiment, the one or more other modules may include additional functionalities to support the creation and rendering of the short spatial content 114. The one or more modules may include modules for user authentication, data management, network communication, and other auxiliary tasks that ensure the seamless operation of the system 108. The data 210 in the memory 208 may include any additional information required by the modules to perform the associated tasks.

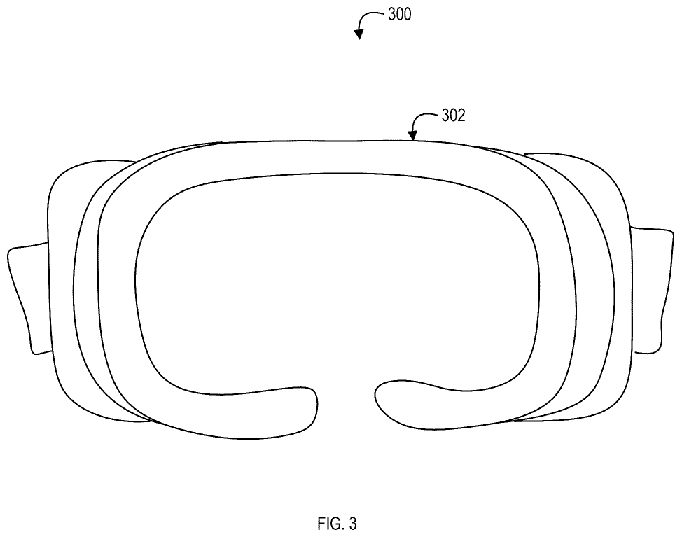

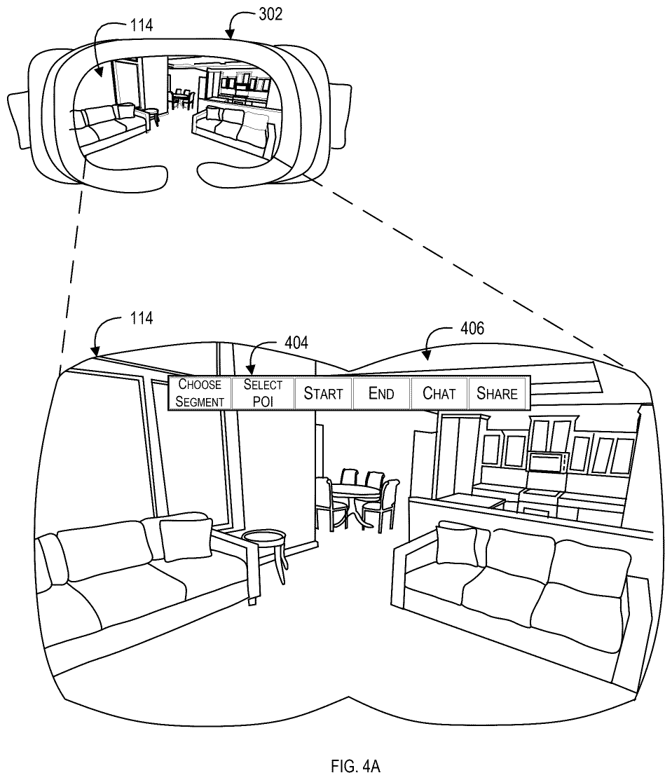

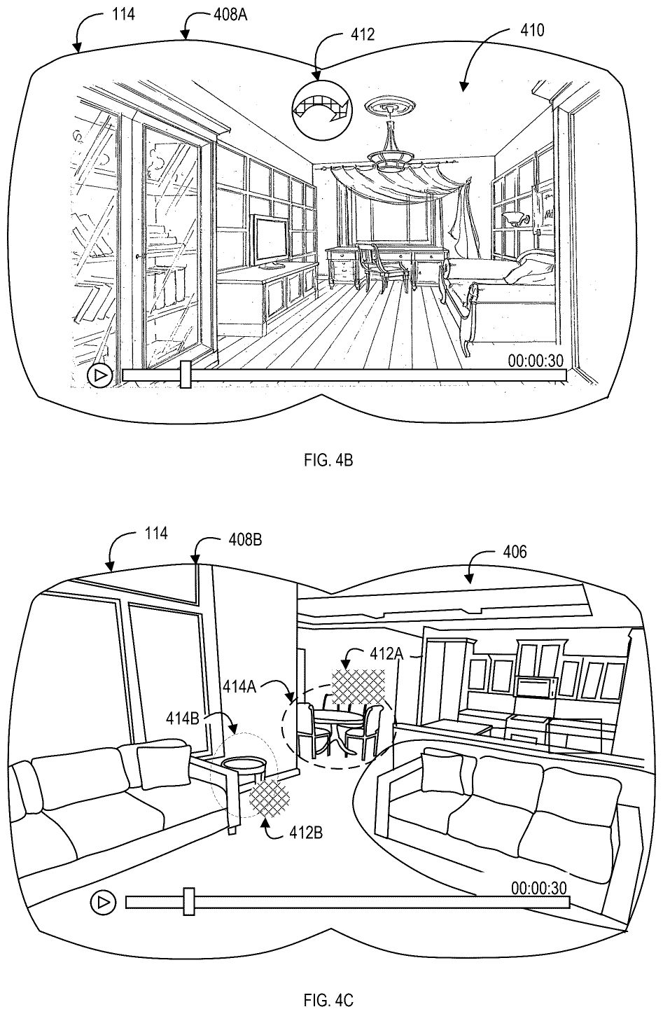

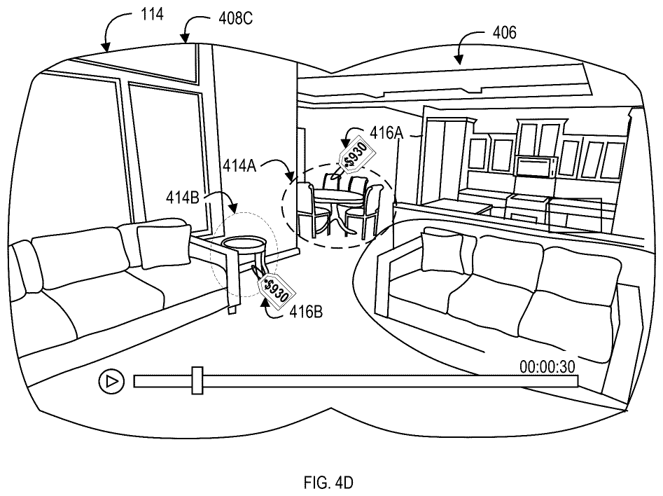

FIG. 3 illustrates an exemplary embodiment 300 of an extended reality device 302, in accordance with an embodiment of the present disclosure. FIG. 4A illustrates an exemplary interface 402A having options for creating the short spatial content 114 from the spatial content. FIGS. 4B-4D illustrate exemplary interfaces 402B, 402C, and 402D showing the short spatial content 114 with one or more exemplary affordances, in accordance with an embodiment of the present disclosure. For the sake of brevity, FIG. 3, and FIG. 4A-4D are explained together.

In an embodiment, the extended reality device may be a Head Mounted Device 302 (HMD 302). In an alternate embodiment, the extended reality device may be any device which can render an extended reality environment to the user 102. In an embodiment the spatial content 112 may be the immersive environment of an apartment (herewith also known as 360-apartment), utilizing spatial content to offer a comprehensive, spherical view of the living space. The 360-apartment may allow apartment exploration from any angle, providing a realistic sense of the layout, dimensions, and features. Further, the 360-apartment may be created using high-resolution imagery or video, and enhanced with spatial metadata. Furthermore, the 360-apartment may enable seamless navigation and interaction within the virtual environment.

In an embodiment, the user 102 equipped with the HMD 302 may choose to create the short spatial content 114 from the 360-apartment. The user 102 may navigate through the 360-apartment, identifying key moments and areas to be included in the short spatial content 114. Further, the user 102 may be facilitated with a control panel 404 on the interface 402 to create the short spatial content 114. The control panel 404 may offer various options for short spatial content creation. The “Choose Segment” option may allow the user 102 to select specific portions from the 360-apartment that they wish to include in the short spatial content 114, ensuring the content is relevant and engaging.

In an embodiment, the “Select POI” (Point of Interest) feature may enable the user 102 to highlight particular areas or objects within the chosen video segment, to guide the viewer's attention to these key elements. For example, the user 102 may point out a specific piece of furniture or a unique architectural detail by specifying the spatial coordinates within the chosen video segment. The “Start” and “End” buttons may let the user 102 define the exact time frames to extract the chosen video segment, to create the short spatial content 114. The created short spatial content 114 may include only the most pertinent parts of the 360-apartment, as defined by the user 102 using the control panel 404. Further, the created short spatial content 114 may include the view 406, based on the user inputs from the control panel 404, extracted from the 360-apartment. The view 406 may be a portion from the extracted segment having one or more POIs based on the user selection. Further, the view 406 may allow the short spatial content 114 to showcase important, impressive, and interesting moments of the 360-apartment, ensuring that the viewer's experience is both engaging and informative.

In an embodiment, additional options, in the control panel 404, such as “Chat” and “Share” may facilitate real-time communication and easy distribution of the created short spatial content 114, enhancing the overall interactive experience. The “Chat” feature may allow the user 102 to discuss and collaborate on the short spatial content 114 creation process, while the “Share” button provides a seamless way to distribute the created short spatial content 114 to other viewers or on social media platforms. By enabling precise control over the content and points of interest, the user 102 may craft engaging, customized short spatial content 114 that highlight the most important aspects of the spatial content 112.

In an embodiment, when the viewer(s) engages with the created short spatial content 114, on a user interface 408A the field of view (FOV) may align with the view 410, which, although part of the created short spatial content 114, may not be the view the user 102 wished to highlight. The misalignment may occur because the FOV during viewer engagement might focus on a different segment or perspective of the created short spatial content 114 than originally intended by the user 102. The discrepancy between the intended and actual views may affect how the key points of interest are presented and perceived by the viewer, potentially impacting the effectiveness and engagement of the short spatial content 114. To address the misalignment, one or more affordances 412 may guide the viewer toward the view 406 as shown in the user interface 408B. In an illustrative example, as shown in FIG. 4B, the one or more affordances 412 may include an arrow. Other exemplary one or more affordances 412 may include descriptive labels providing additional information about the POI, interactive markers that can be selected for more details, or visual cues designed to highlight and guide viewers to key elements within the spatial content. Additional examples may involve embedded pop-up text boxes offering contextual details, color-coded highlights to differentiate various types of POIs, or animated paths leading the viewer's attention to specific areas of interest.

In an embodiment, the one or more affordances 412 may be dynamic, such that the one or more affordances 412 may re-position or adjust in real-time based on the viewer's perspective or user 102 FOV, ensuring continuous orientation and guidance within the 360-degree environment. For example, if the user 102 has embedded additional one or more affordance 412 at the location of a dining table 414A or a side table 414B, in the view 406, the viewer may initially see the one or more affordances 412 such as arrow or label within the interface pointing toward additional one or more affordances 412 that identify as the point of interest. As the viewer follows the one or more affordances 412 and shifts FOV towards the dining table 414A or the side table 414B, the one or more affordances 412 ensures that the POI becomes the focus of their attention. Upon interacting with embedded affordance 412A at the dining table 414A and the embedded affordance 412B at the side table 414B, as shown in the user interface 408C, the viewer may access additional interactive content such as a detailed description of the table, including the material, design, or historical significance, enhancing the informational value of the short spatial content 114. Alternatively, the affordance may display the price 416A of the dinner table 414A and the price 416B of the side table 414B, providing practical and commercial information.

In an embodiment, the one or more affordances 412 reposition themselves based on the viewer's movements, ensuring that guidance and interactive opportunities are continuously available. The one or more affordances 412 may assist in maintaining engagement and ensuring that viewers can explore the short spatial content 114 intuitively, without missing any significant elements due to misalignment of the FOV with the POIs. By embedding such affordances, the user 102 may create rich, informative, and engaging short spatial content 114 that provide viewers with a seamless and interactive exploration experience.

In an embodiment, once the affordances have successfully guided the viewer's field of view (FOV) towards the point of interest (POI), the guidance affordances may disappear, allowing the viewer to have a full and unobstructed experience. Thus, ensuring that the initial navigation aid does not clutter the visual experience once its purpose has been fulfilled. For instance, after following an arrow to the dining table 414A or the side table 414B, and once the table is within the viewer's FOV, the arrow, and labels guiding them would fade away, maintaining the immersive quality of the short spatial content 114 while ensuring viewers have unobstructed access to explore the POI. The viewer may then interact with the embedded affordances to see detailed descriptions, prices, or other relevant information. The interactive content may include text annotations, multimedia elements like audio or video descriptions, or even links to purchase items, enhancing both the informational and commercial value of the short spatial content 114.

In an embodiment, the dynamic nature of the affordances, which guide the viewer smoothly and then disappear, ensures a balance between helpful navigation and an immersive viewing experience. Thus, keeping the viewer engaged and allowing them to fully appreciate the highlights and details of the short spatial content 114 without unnecessary visual distractions.

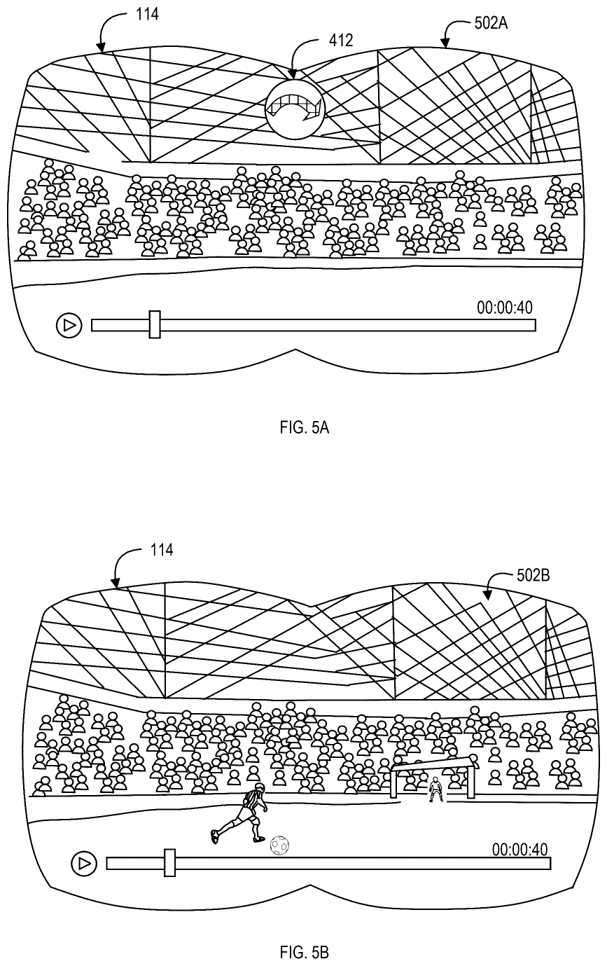

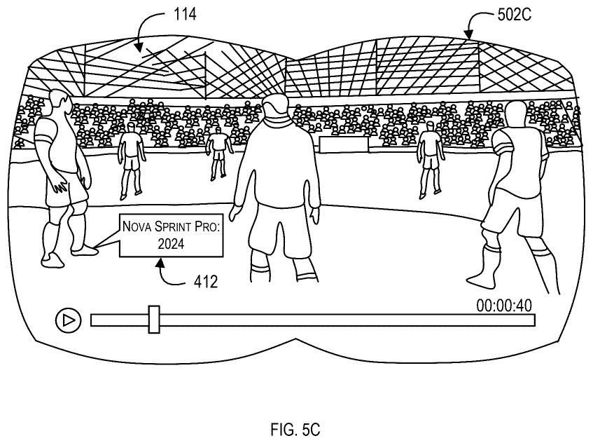

FIGS. 5A-5C illustrate exemplary interfaces during interaction with the short spatial content 114, in accordance with an embodiment of the present disclosure. In an embodiment, the user interface 502A may display a subsequent short spatial content immediately following the short spatial content 114 created from the 360-apartment. In the subsequent short spatial content, the viewer's field of view (FOV) may initially show a crowd or an unrelated scene of a sporting event, as shown in FIG. 5A, due to potential misalignment of the view. To address this misalignment, one or more affordances 412, such as arrows may be strategically placed within the interface 502A. The one or more affordances 412 may guide the viewer's attention to the specific point of interest (POI) that the user 102 (also creator of the now-playing short spatial content) intended to highlight. For example, if the user 102 originally aimed to showcase a significant moment, such as scoring a goal, as shown in FIG. 5B, during a sporting event, the one or more affordance 412 would provide directional one or more affordance 412 to ensure that the viewer's focus shifts toward the goal-scoring event. The one or more affordance 412 may appear as arrows or highlighted labels pointing towards the location of the goal. By following the one or more affordance 412, the viewer may align the FOV with the intended scene, as shown in the user interface 502B, thus enhancing the experience by observing the moment of scoring the goal. Such guidance helps maintain relevance and engagement with the short spatial content 114, ensuring that viewers can easily locate and appreciate the content deemed most important by the creator.

In an embodiment, the viewer may wish to explore other views of the subsequent short spatial content after watching the goal or even during the goal scene. The viewer may do so by interacting with the short spatial content interface to access additional perspectives or information. Further, the viewer may also wish to remove the guidance one or more affordance 412. The removal of the guidance one or more affordance 412 may be accomplished by interacting with the interface to disable or hide the affordance, thus allowing for a more customized viewing experience as shown in the user interface 502C.

In an embodiment, the viewer may wish to enhance the short spatial content 114 by embedding one or more affordances 412, such as directing attention to a player's shoes, as shown in FIG. 5C, the viewer may incorporate such an element into the short spatial content 114. The affordance 412 may display the shoe brand or other relevant details about the player's shoes such as “Nova Sprint Pro: 2024”, enriching the viewer's experience and providing additional context.

In an embodiment, embedding affordance within the short spatial content 114 may only occur if the user 102 i.e. the original creator of the short spatial content 114 grants permission. The viewer may add affordances only with the user 102 approval. The user 102 may retain control over these affordances, with the authority to remove or modify the affordances to ensure that the short spatial content 114 aligns with the creator's intended presentation and interactive experience. It may be apparent to a person skilled in the art that the one or more affordances 412 shown in the Figures are merely for exemplary purposes and may include other affordances known in the art without departing from the scope of the disclosure.

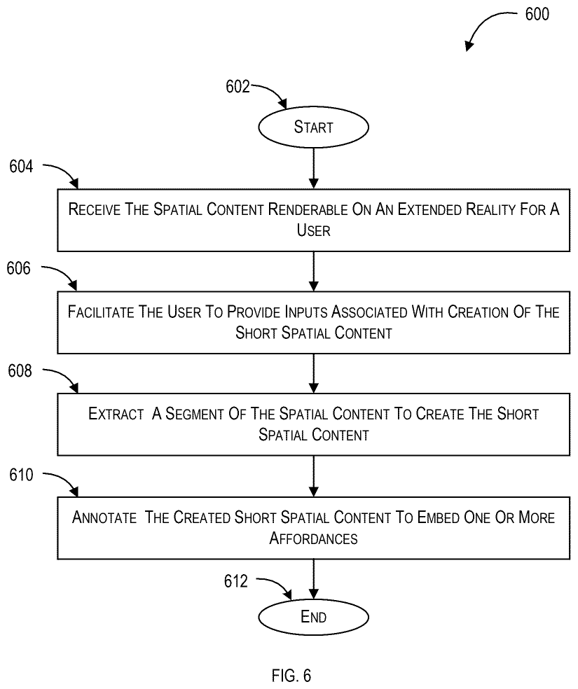

FIG. 6 is an exemplary method for creating short spatial content from the spatial content, in accordance with an embodiment of the present disclosure. For the purpose of this disclosure, the short spatial content may correspond to a short compilation of significant moments from a spatial content. The method starts at step 602.

At step 604, the method includes receiving the spatial content renderable on an extended reality device for a user. The short spatial content may include a short compilation of one or more clips extracted from the spatial content to showcase important, impressive, and interesting moments of the spatial content. By focusing on key scenes and noteworthy events, the short spatial content provides viewers with a focused and dynamic overview of the content, enhancing the viewing experience by showcasing the highlights and pivotal moments that make the spatial content compelling and memorable.

Next at step 606, the method includes facilitating the user to provide one or more inputs associated with creation of the short spatial content. The one or more inputs may include an initiation trigger, spatial coordinates of one or more points of interest, a start time, and/or an end time. The initiating trigger may include hand gestures, figure gestures, touch, audio, text, and/or eye movement. The eye movement may include gazing at the one or more points of interest for a pre-defined time interval. The one or more spatial coordinates may include 3-dimensional coordinates associated with an angle and/or an elevation of one or more frames of the points of interest.

Next at step 608, the method includes extracting, a segment of the spatial content based on the received one or more inputs to create the short spatial content. The extraction may be initiated upon receiving the initiation trigger. The extracted segment may be a brief collection of clips extracted from the spatial content, highlighting key, notable, and engaging moments. Further, the extracted segment may focus on impressive and engaging scenes, thereby providing a clear and impactful overview of the content.

Next at step 610, the method includes creating the short spatial content to embed one or more affordances, based at least on one or more points of interest, for a vivid display of the created short spatial content. The one or more affordances may be annotated, based at least on one or more points of interest. In one instance, the one or more affordances may include direction labels to facilitate a viewer to change Point-Of-View (POV) to the one or more points of interest based on the corresponding spatial coordinate. In another instance, the one or more affordances may be dynamic, such that the one or more affordances may re-position based on the POV of the viewer. Moreover, the one or more affordances may include audio, video, text, emoji, zoom, auditory cues, interactive 3D model, hyperlinks, map, and/or social interaction tools. The method ends at step 612

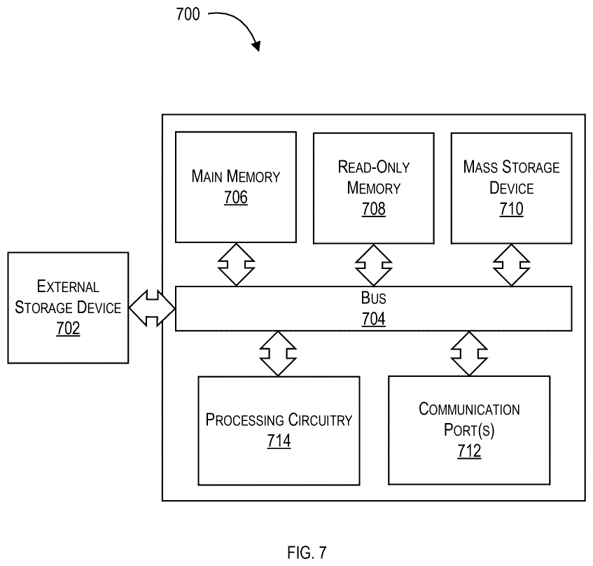

FIG. 7 illustrates an exemplary computer system in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. As shown in FIG. 7, the computer system 700 includes an external storage device 702, bus 704, main memory 706, read-only memory 708, mass storage device 710, communication port(s) 712, and processing circuitry 714.

Those skilled in the art will appreciate that the computer system 700 may include more than one processing circuitry 714 and one or more communication ports 712. The processing circuitry 714 should be understood to mean circuitry based on one or more microprocessors, microcontrollers, digital signal processors, programmable logic devices, Field-Programmable Gate Arrays (FPGAs), Application-Specific Integrated Circuits (ASICs), etc., and may include a multi-core processor (e.g., dual-core, quadcore, Hexa-core, or any suitable number of cores) or supercomputer. In some embodiments, the processing circuitry 714 is distributed across multiple separate processors or processing units, for example, multiple of the same type of processing units (e.g., two Intel Core i7 processors) or multiple different processors (e.g., an Intel Core i5 processor and an Intel Core i7 processor). Examples of the processing circuitry 714 include, but are not limited to, an Intel® Itanium® or Itanium 2 processor(s), or AMD® Opteron® or Athlon MP® processor(s), Motorola® lines of processors, System on Chip (SoC) processors or other future processors. The processing circuitry 714 may include various modules associated with embodiments of the present disclosure.

The communication port 712 may include a cable modem, Integrated Services Digital Network (ISDN) modem, a Digital Subscriber Line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. The communication port 712 may be any RS-232 port for use with a modem-based dialup connection, a 10/100 Ethernet port, a Gigabit, or a 10 Gigabit port using copper or fiber, a serial port, a parallel port, or other existing or future ports. The communication port 712 may be chosen depending on a network, such as a Local Area Network (LAN), Wide Area Network (WAN), or any network to which the computer system 700 may be connected.

The main memory 706 may include Random Access Memory (RAM) or any other dynamic storage device commonly known in the art. Read-only memory (ROM) 708 may be any static storage device(s), e.g., but not limited to, a Programmable Read-Only Memory (PROM) chips for storing static information, e.g., start-up or BIOS instructions for the processing circuitry 714.

The mass storage device 710 may be an electronic storage device. As referred to herein, the phrase “electronic storage device” or “storage device” should be understood to mean any device for storing electronic data, computer software, or firmware, such as random-access memory, read-only memory, hard drives, optical drives, Digital Video Disc (DVD) recorders, Compact Disc (CD) recorders, BLU-RAY disc (BD) recorders, BLU-RAY 3D disc recorders, Digital Video Recorders (DVRs, sometimes called a personal video recorder or PVRs), solid-state devices, quantum storage devices, gaming consoles, gaming media, or any other suitable fixed or removable storage devices, and/or any combination of the same. Nonvolatile memory may also be used (e.g., to launch a boot-up routine and other instructions). Cloud-based storage may be used to supplement the main memory 706. The mass storage device 710 may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

The bus 704 communicatively couples the processing circuitry 714 with the other memory, storage, and communication blocks. The bus 704 may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processing circuitry 714 to the software system.

Optionally, operator and administrative interfaces, e.g., a display, keyboard, and a cursor control device, may also be coupled to the bus 704 to support direct operator interaction with the computer system 700. Other operator and administrative interfaces may be provided through network connections connected through the communication port(s) 712. The external storage device 702 may be any kind of external hard drives, floppy drives, IOMEGA® Zip Drives, Compact Disc—Read-Only Memory (CD-ROM), Compact Disc—Re-Writable (CD-RW), Digital Video Disk—Read Only Memory (DVD-ROM). The components described above are meant only to exemplify various possibilities. In no way should the aforementioned exemplary computer system limit the scope of the present disclosure.

The computer system 700 may be accessed through a user interface. The user interface application may be implemented using any suitable architecture. For example, it may be a stand-alone application wholly implemented on the computer system 700. The user interfaces application and/or any instructions for performing any of the embodiments discussed herein may be encoded on computer-readable media. Computer-readable media includes any media capable of storing data. In some embodiments, the user interface application is a client-server-based application. Data for use by a thick or thin client implemented on electronic device computer system 700 is retrieved on-demand by issuing requests to a server remote to the computer system 700. For example, computer system 700 may receive inputs from the user via an input interface and transmit those inputs to the remote server for processing and generating the corresponding outputs. The generated output is then transmitted to the computer system 700 for presentation to the user.

While embodiments of the present invention have been illustrated and described, it will be clear that the invention is not limited to these embodiments only. Numerous modifications, changes, variations, substitutions, and equivalents, will be apparent to those skilled in the art without departing from the spirit and scope of the invention, as described in the claims.

The disclosed system, method, and computer program product (together termed as ‘disclosed mechanism’) for creating short spatial content from a spatial content provides a robust solution for enhancing user engagement and the viewing experience in immersive environments. The disclosed mechanism shortens the spatial content, called short spatial content, to focus on interesting parts, thereby minimizing unnecessary viewing time and enhancing the overall impact of the video. Further, the disclosed mechanism ensures viewers receive a concentrated and engaging experience without the distraction of less relevant segments by emphasizing key moments and Points Of Interest (POI). Furthermore, the disclosed mechanism guides users through various points of interest (POIs) in the short spatial content. Further, the mechanism includes embedded direction labels and other affordances that help users seamlessly navigate the content, ensuring they do not miss any critical parts. For example, consider a spatial content of a scenic tour. A user might be interested in specific landmarks or viewpoints. The mechanism allows the user to mark these POIs, and when the short spatial content is created, it includes direction labels guiding viewers to these landmarks. This ensures that viewers can effortlessly follow the tour and fully appreciate the highlighted moments without losing their sense of orientation.

The embedded dynamic affordances, such as direction labels, audio, video, text, emojis, and interactive 3D models, adapt to the viewer's field of view (FOV), maintaining relevance and utility as viewers shift their perspectives. As viewers change their FOV, the direction labels and other interactive elements reposition themselves to remain relevant and useful. The dynamic adaptation ensures viewers remain oriented and maintains a continuous, fluid experience, thereby significantly enhancing the overall viewing experience.

By creating short, compelling short spatial content that showcase the most engaging parts of the spatial content, users can easily share highlights across various platforms. This makes the content more appealing and shareable, increasing its reach and impact.

Overall, the disclosed mechanism significantly enhances the user experience in spatial content environments by providing intuitive navigation, dynamic interactive elements, and an efficient content creation process. By providing intuitive navigation, dynamic affordances, and a streamlined content creation process, the mechanism ensures that users can easily create and share compelling short spatial content that captivate and engage viewers.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed is:

1. A system for creating a short spatial content from a spatial content, the system comprising:
a receiver to receive the spatial content renderable on an extended reality for a user;
a user-interface to facilitate the user to provide one or more inputs associated with creation of the short spatial content, wherein the one or more inputs include at least one of: an initiation trigger, spatial coordinates of one or more points of interest, a start time, and an end time;
an extractor to extract, upon receiving the initiation trigger, a segment of the spatial content based on the received one or more inputs to create the short spatial content; and
a renderer to annotate the created short spatial content to embed one or more affordances, based at least on one or more points of interest, for a vivid display of the created short spatial content, wherein the one or more affordances include at least direction labels to facilitate a viewer to change Point-Of-View (POV) to the one or more points of interest based on the corresponding spatial coordinate.

2. The system of claim 1, wherein the one or more spatial coordinates correspond to 3-dimensional coordinates associated with at least one of: an angle and an elevation of one or more frames of the points of interest.

3. The system of claim 1, wherein the initiating trigger includes at least one of: hand gestures, figure gestures, touch, audio, text, and eye movement.

4. The system of claim 3, wherein the eye movement corresponds to gazing at the one or more points of interest for a pre-defined time interval.

5. The system of claim 1, wherein the one or more affordances are dynamic, such that the one or more affordances re-position based on the POV of the viewer.

6. The system of claim 1, wherein the one or more affordances further include at least one of: audio, video, text, emoji, zoom, auditory cues, interactive 3D model, hyperlinks, map, and social interaction tools.

7. The system of claim 1, wherein the short spatial content corresponds to a short compilation of one or more clips extracted from the spatial content to showcase at least one of: important, impressive, and interesting moments of the spatial content.

8. A method for creating a short spatial content from a spatial content, the method comprising:
receiving, by a system, the spatial content renderable on an extended reality for a user;
facilitating, by a system, the user to provide one or more inputs associated with creation of the short spatial content, wherein the one or more inputs include at least one of: an initiation trigger, spatial coordinates of one or more points of interest, a start time, and an end time;
extracting, by a system, upon receiving the initiation trigger, a segment of the spatial content based on the received one or more inputs to create the short spatial content; and
annotating, by a system, the created short spatial content to embed one or more affordances, based at least on one or more points of interest, for a vivid display of the created short spatial content, wherein the one or more affordances include at least direction labels to facilitate a viewer to change Point-Of-View (POV) to the one or more points of interest based on the corresponding spatial coordinate.

9. The method of claim 8, wherein the one or more spatial coordinates correspond to 3-dimensional coordinates associated with at least one of: an angle and an elevation of one or more frames of the points of interest.

10. The method of claim 8, wherein the initiating trigger includes at least one of: hand gestures, figure gestures, touch, audio, text, and eye movement.

11. The method of claim 10, wherein the eye movement corresponds to gazing at the one or more points of interest for a pre-defined time interval.

12. The method of claim 8, wherein the one or more affordances are dynamic, such that the one or more affordances re-position based on the POV of the viewer.

13. The method of claim 8, wherein the one or more affordances further include at least one of: audio, video, text, emoji, zoom, auditory cues, interactive 3D model, hyperlinks, map, and social interaction tools.

14. The method of claim 8, wherein the short spatial content corresponds to a short compilation of one or more clips extracted from the spatial content to showcase at least one of: important, impressive, and interesting moments of the spatial content.

15. A computer program product including at least one non-transitory computer-readable storage medium having computer-executable program code portions stored therein, the computer program product is configured to:
receive the spatial content renderable on an extended reality device for a user;
facilitate the user to provide one or more inputs associated with creation of the short spatial content, wherein the one or more inputs include at least one of: an initiation trigger, spatial coordinates of one or more points of interest, a start time, and an end time;
extract upon receiving the initiation trigger, a segment of the spatial content based on the received one or more inputs to create the short spatial content; and
annotate the created short spatial content to embed one or more affordances, based at least on one or more points of interest, for a vivid display of the created short spatial content, wherein the one or more affordances include at least direction labels to facilitate a viewer to change Point-Of-View (POV) to the one or more points of interest based on the corresponding spatial coordinate.

16. The computer program product of claim 15, wherein the one or more spatial coordinates correspond to 3-dimensional coordinates associated with at least one of: an angle and an elevation of one or more frames of the points of interest.

17. The computer program product of claim 15,
wherein the initiating trigger includes at least one of: hand gesture, figure gesture, touch, audio, text, and eye movement;
wherein the eye movement corresponds to gazing at the one or more points of interest for a pre-defined time interval.

18. The computer program product of claim 15, wherein the one or more affordances are dynamic, such that the one or more affordances re-position based on the POV of the viewer.

19. The computer program product of claim 15, wherein the one or more affordances further include at least one of: audio, video, text, emoji, zoom, auditory cues, interactive 3D model, hyperlinks, map, and social interaction tools.

20. The computer program product of claim 15, wherein the short spatial content corresponds to a short compilation of one or more clips extracted from the spatial content to showcase at least one of: important, impressive, and interesting moments of the spatial content.
